(19) United States
(12) Patent Application Publication
(10) Pub. No.: US 2020/0266013 A1
(43) Pub. Date: Aug. 20, 2020

(54) MECHANICAL KEYPAD

(71) Applicant: VeriFone, Inc., San Jose, CA (US)

(72) Inventors: Travis Schraeder, Fair Oaks, CA (US); Igal Yanko, Rocklin, CA (US)

(21) Appl. No.: 16/280,611

(22) Filed: Feb. 20, 2019

(51) Int. Cl. H01H 13/86; G05G 1/01; G05G 1/02; G05G 23/00

(52) U.S. Cl. CPC H01H 13/86; G05G 1/01; G05G 1/02; H01H 2231/006; H01H 2239/032; H01H 2239/038; H01H 2217/01; G05G 23/00

(57) ABSTRACT

Mechanical keypads are disclosed. According to one embodiment, a mechanical keypad may include a key cap comprising a post extending from a bottom surface thereof; a structural element comprising a passage configured to receive the post therethrough; and a key securing device that securely receives, through the passage, the post in a recess or opening formed therein, and comprising a key switch interface on a lower surface thereof. The key cap and the key securing device may move substantially in unison when the key post is securely received in the key securing device.

### BACKGROUND OF THE INVENTION

### 1. Field of the Invention

The present disclosure relates generally to a mechanical keypad.

### 2. Description of the Related Art

Mechanical keypads are commonly found on point of sale devices, ATMs, etc. and are sometimes the only point of interaction that a person has with such devices. These mechanical keypads may also be a target of tampering. For example, an attacker may attempt to access a secure area of a keypad by removing one of the keys. Such access may lead to the compromise of secure information.

### SUMMARY OF THE INVENTION

Mechanical keypads are disclosed. According to one embodiment, a mechanical keypad may include a key cap comprising a post extending from a bottom surface thereof; a structural element comprising a passage configured to receive the post therethrough; and a key securing device that securely receives, through the passage, the post in a recess or opening formed therein, and comprising a key switch interface on a lower surface thereof. The key cap and the key securing device may move substantially in unison when the key post is securely received in the key securing device.

In one embodiment, the mechanical keypad may include a spring between the structural element and the key cap, such that when the key cap is depressed, the spring compresses, causing the key securing device to travel a shorter distance than a distance travelled by the key cap.

In one embodiment, the key securing device may be configured to be damaged when the key post is removed from the recess or opening.

In one embodiment, the post may be mechanically secured in the key securing device.

In one embodiment, the mechanical keypad may include a plurality of posts.

In one embodiment, the mechanical keypad may include a web between the key cap and the structural element that prevents ingress of debris and foreign matter into the structural element.

In one embodiment, the mechanical keypad may include a key switch for interacting with the key switch interface, wherein depressing the key cap causes the key switch interface to actuate the key switch.

In one embodiment, the key securing device may be mechanically unstable with respect to the key switch when the post is not received in the recess or opening therein.

In one embodiment, a lower surface of the key securing device may have a convex portion.

In one embodiment, the key switch interface may protrude from a lower surface of the key securing device.

According to another embodiment, a mechanical keypad may include a key cap having a plurality of posts extending from a bottom surface thereof; a structural element comprising a plurality of passages formed therethrough; a key securing device that securely receives the plurality of posts on an opposite side of the structural element from the key cap in a post-receiving structure formed therein, the key securing device comprising a key switch interface on a lower surface thereof; and a key switch layer comprising a key switch that interacts with the key switch interface and registering a key press. The key securing device may be mechanically unstable with respect to the key switch when not properly engaged with the plurality of posts, and the key cap and the key securing device may move substantially in unison when the key posts are securely received in the key securing device, and depressing the key cap causes the key switch interface that securely receives the key posts for the key cap to actuate the key switch.

In one embodiment, the key securing device may be configured to be damaged when the key post is removed.

In one embodiment, the post receiving structure may include a recess.

In one embodiment, the post receiving structure may include an opening.

In one embodiment, the key switch may be centered between the plurality of posts.

In one embodiment, the mechanical keypad may be positioned in a housing, and may include an alarm switch having a security element associated therewith, the security element positioned between the housing and the alarm switch such that when the housing and the alarm switch are separated, the alarm switch is activated.

In one embodiment, a bottom surface of the key securing device may have a convex portion.

In one embodiment, the key switch interface may protrude from the key securing device.

In one embodiment, the structural element may include a recess formed on a lower surface thereof, wherein the recess is provided for the key securing device.

In one embodiment, the mechanical keypad may include a spring between the structural element and the key cap such that when the key cap is depressed, the spring compresses before the key securing device moves.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a mechanical keypad according to one embodiment;

FIG. 2 depicts a section view of a mechanical keypad according to one embodiment;

FIG. 3 depicts a sectional view of a key securing device along its length according to one embodiment; and

FIGS. 4A and 4B depict an embodiment in which a key cap is depressed on a lateral edge thereof.

### DETAILED DESCRIPTION OF PREFERRED EMBODIMENTS

Embodiments are directed to mechanical keypads. Embodiments may use a key securing device, such as a key security clip, to secure one or more posts of a key cap through a structural component, such as a light guide. The key cap does not directly actuate a key switch (e.g., a key metal dome switch); instead, the key switch is actuated by the key securing device.

In embodiments, the key securing device may include a raised feature, such as a key switch interface, to interact with the key switch. If the key securing device is not in place, is not aligned correctly, is damaged, etc. the key cap may not properly actuate the key switch.

Embodiments may provide additional security features. For example, in embodiments, the key securing device may function to prevent unwanted key cap removal, such as by vandalism, security attacks, etc. In one embodiment, if the key cap is removed, it is difficult or impossible to reattach the key securing device to the post of the key cap without gaining access to a secure interior of the device. Such access to the secure interior may activate a security device (e.g., an alarm switch, a case open switch, etc.), thereby detecting the attack.

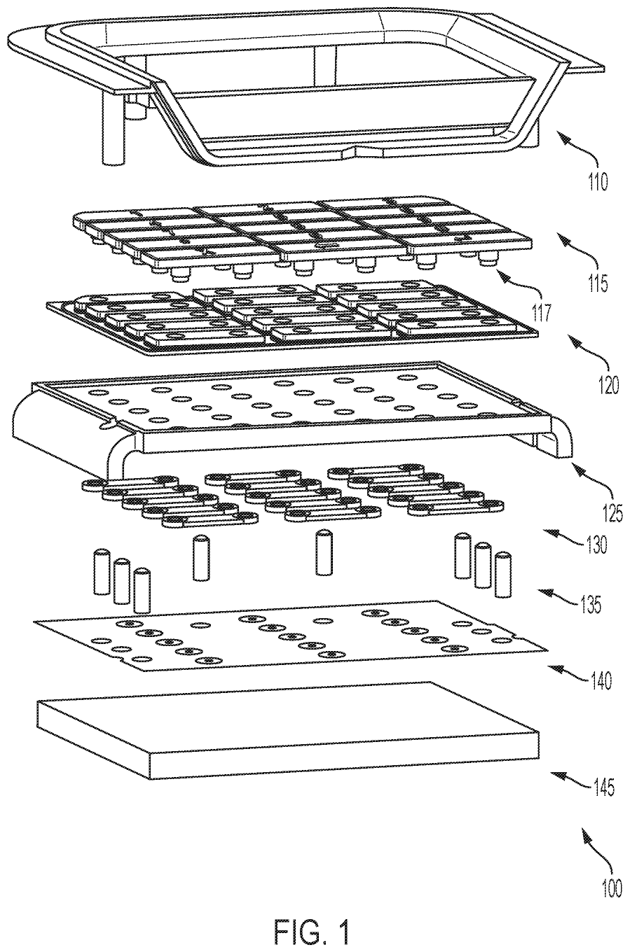

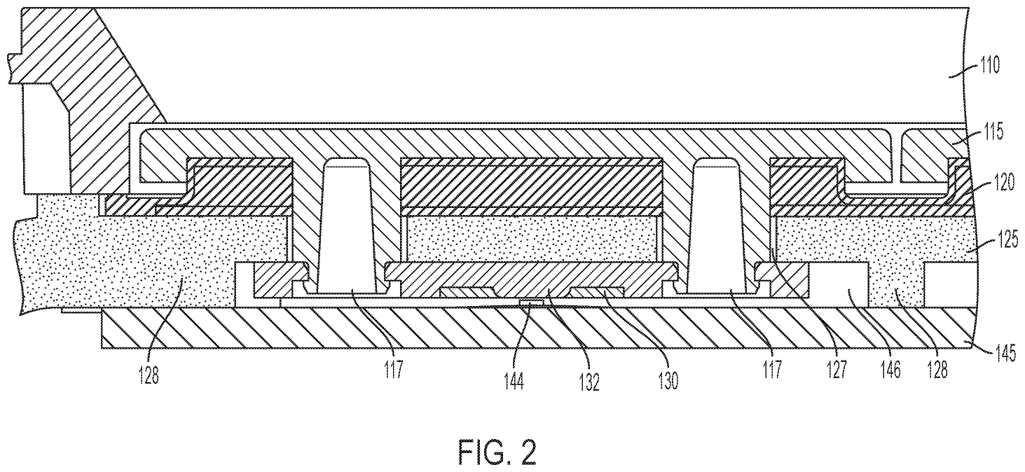

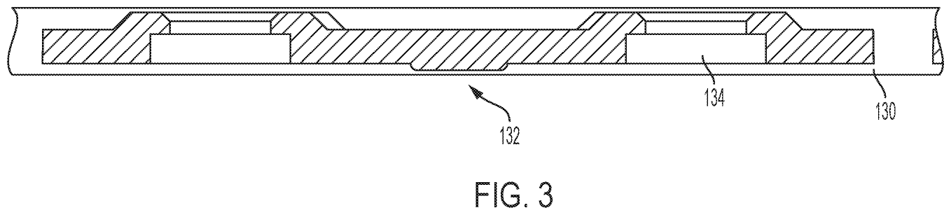

Referring to FIGS. 1-3, a mechanical keypad is disclosed according to embodiments. FIG. 1 depicts an exploded view of a mechanical keypad according to one embodiment. FIG. 2 depicts a sectional view of the mechanical keyboard. FIG. 3 depicts a section view of key securing device 130 along its length.

Embodiments of mechanical keypad 100 may include top case 110, key caps 115, web 120, structural element 125, key securing devices 130, security elements 135 such as a case open switch or parts thereof, key switch layer 140, and frame 145.

In one embodiment, top case 110 may be part of a housing in which the keypad is provided. Examples of housings include ATM housings, point of sale device housing, keypad lock housings, or any other suitable housing in which security of the key switches and/or electronics provided under the keypad is desired.

In one embodiment, key caps 115 may be provided in a mat of key caps, as individual key caps, etc.

In one embodiment, each key cap 115 may have one or more posts 117 provided on the underside thereof. Posts 117 may be provided on the underside of key cap 115 in any suitable manner, and at any suitable location. For example, if one post 117 is provided, it may be provided in the center of key cap 115, or it may be offset from the center. If multiple posts 117 are used, they may be placed symmetrically, asymmetrically, etc. For example, if two posts 117 are provided, then the two posts 117 may be placed equidistant from the center of the key cap 115 and along a line that bisects the key cap 115. Other arrangements of multiple posts 117 may also be used.

In one embodiment, posts 117 may be formed as part of key cap 115.

Web 120 may be provided and shaped to prevent ingress of debris and foreign matter, such as dirt, water, etc. into structural element 125. In one embodiment, web 120 may be made of a flexible material, such as silicone, silicone rubber, etc.

In one embodiment, each key cap 115 may be joined to web 120 using, for example, adhesives.

In one embodiment, web 120 may provide a bias to return key caps 115 to an upward position. Web 120 may also hold key caps 115 in their intended positions. Web 120 may further prevent or reduce light leakage if opaque or masked with an opaque layer.

Structural element 125 may provide a structural base for key caps 115. In one embodiment, posts 117 from key caps 115 may pass through passages, holes, openings, or apertures 127 in structural element 125 and may move with little, if any, resistance from structural element 125. For example, posts 117 may slide in passages, holes, openings, or apertures 127 formed in structural element 125.

In one embodiment, structural element 125 may be a light guide that may be used to provide back lighting for key caps 115. Structural element 125 may provide any additional functions as is necessary and/or desired.

Key securing devices 130 may be provided on the opposite side of structural element 125 and may include one or more post receiving structure 134, such as openings or recesses, each to receive one of posts 117. Each key cap 115 may be provided with a corresponding key securing device 130.

In one embodiment, a top portion of key securing device 130 may be in contact with a lower surface of structural element when key cap 115 is not actuated or depressed.

Key securing devices 130 may securely engage posts 117 such that key cap 115 and corresponding key securing device 130 move in unison when engaged. For example, posts 117 may engage opening or recesses 134 formed in key securing devices 130 in a clickable manner. For example, during assembly, posts 117 may be pushed into openings or recesses 134 of key securing devices 130 and may remain connected by a mechanical force, such as friction, or a one-way flexible collar, or flange, that may engage with a notched portion of post 117, so that key cap 115 and key securing device 130 move in unison, or substantially in unison, when connected. In another embodiment, posts 117 may be secured in key securing devices 130 using adhesive, heat staking, welding, fastener clip, pin clips, etc. Other manners of connection may be used as is necessary and/or desired.

In another embodiment, key securing devices 130 may engage posts 117 such that key cap 115 and corresponding key securing device 130 may move in unison, but travel different distances. For example, a spring (not shown) may be provided between posts 117 and key securing device 130. In this arrangement, while key cap 115 and key securing device 130 move substantially in unison, key cap 115 may travel a greater distance than key securing device 130 moves because the spring will compress causing key securing device 130 to move a shorter distance than the distance travelled by key cap 115.

In one embodiment, if any of key caps 115 is unwantedly removed, one or more of posts 117 are removed from key securing device 130, which may cause key securing device 130 to be damaged to the point where post 117 cannot be re-inserted securely to allow proper operation of the keypad. For example, key securing device 130 may include break points (not shown) such that when sufficient force is applied in an attempt to pry key cap 115 off, key securing device 130 is damaged, breaks, etc. such that posts 117 cannot re-engage with key securing device 130 properly. In another embodiment, the securing mechanism in recess or opening 134 may be damaged such that key cap 115 and key securing device 130 would not be able to be properly reengaged. For example, post 117 and opening 134 may not be able to engage with each other or key cap 115 and key securing device 130 would not move in unison if post 117 were re-inserted into recess or opening 134.

Key securing device 130 may have a tab or other structure (not shown) that engages with post 117 upon assembly and secure post 117 to key securing device 130. Upon forced disengagement, the tab or other structure may break off, or otherwise be damaged, such that when reengagement of post 117 to key securing device 130 is attempted, the two cannot be securely reengaged. In another embodiment, post 117 may include a securing mechanism (not shown) to secure it to the key securing structure 130 that may be damaged if the key cap is forcefully removed. For example, post 117 may have a flexible tab (not shown) that allows it to be inserted into and secured to key securing structure 130, or a pin or open clip fastener (not shown) that may be affixed to the post during assembly to secure it in place with respect to the key security structure. When forcefully removed, the tab, pin, open clip fastener or similar mechanism will be damaged or cause damage to post 117, key securing structure 130, or both such that they cannot be properly and securely reengaged.

In one embodiment, key securing device 130 may be a single-use device.

Key securing device 130 may further include key switch interface 132 on its lower surface. Key switch interface 132 may correspond to, and interface with, key switch 144.

One or more alarm switch (not shown) may be provided on or with key switch layer 140, frame 145, on printed circuit board (not shown), etc. For example, the alarm switch may take the form of a case open switch. For example, each alarm switch may interact with a security element 135 that may be positioned between top case 110 and the alarm switch. In another embodiment, security element may be positioned between structural element 125 and alarm switch. Thus, when top case 110 and/or structural element 125 is removed, lifted, or separated from key switch layer 140, frame 145, and/or the printed circuit board or its position is otherwise altered, the alarm switch may recognize this alternation and may trigger an alarm.

For example, in one embodiment, security element 135 may be a security plunger that in its unaltered state has a downward force applied to it that causes the plunger to similarly engage with the alarm switch. If the frame of the device were to be opened or otherwise tampered, the downward force may be changed, reduced, or eliminated, which may cause the security plunger to disengage with the alarm switch and trigger an alarm.

In one embodiment, security elements 135 may extend through key switch layer 140 into frame 145 to interact with the printed circuit board (not shown) that may be inside or below frame 145. In one embodiment security element 135 may be an integral part of the top case 110, structural element 125, or web 120.

In one embodiment, recesses (not shown) may be provided in structural element 125 for receiving an end of security elements 135. In another embodiment, through-holes may be provided in structural element 125 to allow security elements 135 to pass through structural element 125.

Key switch layer 140 may include one or more key switches 144. Each key switch 144 may be associated with a key cap 115. Key switches 144 may be formed as domes on key switch layer 140.

Key switches 144 may be offset from posts 117 and passages, holes, openings, or apertures 127 such that key switch 144 may not be directly accessible through passages, holes, openings, or apertures 127 if key cap 115 were removed. For example, key switch 144 may be positioned between recess or opening 134 in key securing device 130.

In one embodiment, key switch layer 140 may be metal.

In one embodiment, key switch layer 140 may be part of a printed circuit board.

In one embodiment, each key switch 144 may be formed as a plurality of layers. For example, a first layer may include convex domes, and a second layer may include switch circuitry. The first layer may be adhered to, laid on top of, etc. the switch circuitry, such that when the first layer is depressed, contacted, etc., the switch circuitry is actuated.

Other designs and mechanisms for key switch 144, such as mechanical switches, carbon pill switches, etc. may be used as is necessary and/or desired.

In another embodiment, key switches 144 may protrude from the plane of key switch layer. For example, key switches 144 may be comprised of a metal dome that, when depressed, causes the key press to register.

In one embodiment, key securing device 130 may have a lower surface shape that is mechanically unstable with regard to key switch layer 140 and/or key switches 144. For example, key securing device 130 may have a convex lower surface, and key switch layer 140 may include key switch 144 that has a dome shaped structure made of metal or other suitable substance, such that when key securing device 130 is properly engaged, the lower surface of key securing device 130 (e.g. key switch interface 132) compresses the dome to register a key press. If, however, key cap 115 is disengaged from key securing device 130, because the lower surface of key securing device 130 does not lie flat against key switch layer 140 and/or the dome of key switch 144, key securing device 130 will not be in alignment with key switch 144. Thus, key switch 144 will not register a key press when key cap 115 is depressed.

In one embodiment, the mechanical instability that results from the shape of the lower surface of key securing device 130 and/or key switch 144 does not allow key securing device 130 to easily rest in proper alignment with the key switch assembly. Thus, it is difficult to re-insert posts 117 of key cap 115 into key securing device 130 when key cap 115 has been removed or detached from key securing device 130.

In another embodiment, the lower surface of key securing device 130 may include a ridge or any other suitable shape that increases the mechanical instability of security device and key switch layer 140, therefore making it difficult to align key cap 115 with key securing device 130 so depressing key cap 115 actuates key switch 144.

In one embodiment, structural element 125 may be configured to include one or more of recesses 146 on a lower surface thereof. In one embodiment, a single recess 146 may be provided in which all key switches 144 are positioned. Thus, in this embodiment, there is no mechanism for containing a detached key securing device 130 near its associated key switch 144.

In another embodiment, a plurality of key switches 144 may be positioned within each recess 146. For example, a recess may be provided vertically or horizontally for all key switches 144 in a row or column. Thus, in this embodiment, a detached key securing device 130 will be retained in the recess for its column or row, but it will still be difficult to align and reattach key securing devices 130 to a corresponding post 117.

In another embodiment, recesses 146 may be provided for each key switch 144. Thus, in this embodiment, a detached key securing device 130 may be retained in the recess for its key switch. Recesses 146 may be formed to be larger than key securing devices 130 to allow for movement of any key securing device 130 that is removed, disengaged, or detached from a corresponding post 117 of key cap 130, allowing for the benefit of difficult alignment and reattachment of key securing device 130 to the corresponding post 117 of key cap 115.

In one embodiment, recesses 146 may be formed by ribs 128 formed in structural element 125. The number and orientation of ribs 128 may vary as is necessary and/or desired.

Frame 145 may provide a base for the keypad and may house internal components, such as processors, memory, etc.

Referring to FIG. 3, a section view of key securing device 130 along its length is provided. Key securing device 130 may include key switch interface 132 on its lower surface. Key switch interface 132 may be convex such that it promotes mechanical instability with key switch layer 140. In one embodiment, when posts 117 are secured in key securing device 130, key switch interface 132 may be in alignment with one of key switches 144.

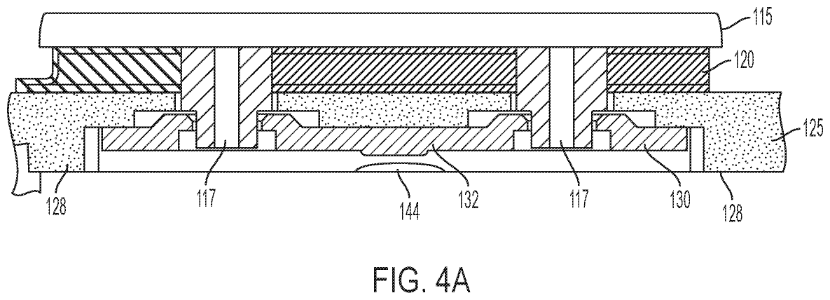

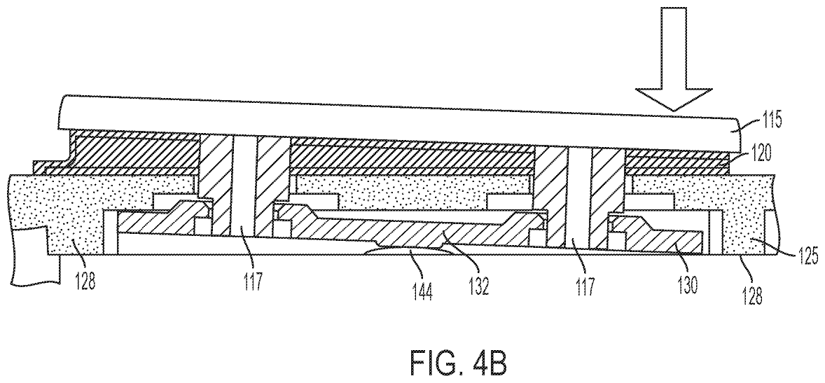

Referring to FIGS. 4A and 4B, key cap 115 may have a shape such that key cap 115 may be depressed on lateral end of key cap 115 between post 117 and an edge of key cap 115. For example, in one embodiment, key cap 115 may interface with key securing device 130 such that when key cap 115 is pressed on a lateral end thereof, the interaction of posts 117 and structural element 125 forces key cap 115 and key securing device 130 to move in a downward direction, therefore providing an acceptable feel to the user. Key securing device 130 creates a pivot point at the side opposite the end which is pressed, which results in a lever action that helps to engage key switch 144, even though the key cap 115 was pressed off-center.

It will be appreciated by persons skilled in the art that the present invention is not limited by what has been particularly shown and described hereinabove. Rather the scope of the present invention includes both combinations and sub-combinations of features described hereinabove and variations and modifications thereof which are not in the prior art. It should further be recognized that these embodiments are not exclusive to each other.

It will be readily understood by those persons skilled in the art that the embodiments disclosed here are susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A mechanical keypad comprising:
a key cap comprising a post extending from a bottom surface thereof;
a structural element comprising a passage configured to receive the post therethrough; and
a key securing device that securely receives, through the passage, the post in a recess or opening formed therein, and comprising a key switch interface on a lower surface thereof;
wherein the key cap and the key securing device move substantially in unison when the key post is securely received in the key securing device.

2. The mechanical keypad of claim 1, further comprising a spring between the structural element and the key cap, such that when the key cap is depressed, the spring compresses, causing the key securing device to travel a shorter distance than a distance travelled by the key cap.

3. The mechanical keypad of claim 1, wherein the key securing device is configured to be damaged when the key post is removed from the recess or opening.

4. The mechanical keypad of claim 1, wherein the post is mechanically secured in the key securing device.

5. The mechanical keypad of claim 1, further comprising a plurality of posts.

6. The mechanical keypad of claim 1, further comprising:
a web between the key cap and the structural element that prevents ingress of debris and foreign matter into the structural element.

7. The mechanical keypad of claim 1, further comprising:
a key switch for interacting with the key switch interface;
wherein depressing the key cap causes the key switch interface to actuate the key switch.

8. The mechanical keypad of claim 1, wherein the key securing device is mechanically unstable with respect to the key switch when the post is not received in the recess or opening therein.

9. The mechanical keypad of claim 1, wherein a lower surface of the key securing device comprises a convex portion.

10. The mechanical keypad of claim 1, wherein the key switch interface protrudes from a lower surface of the key securing device.

11. A mechanical keypad comprising:
a key cap having a plurality of posts extending from a bottom surface thereof;
a structural element comprising a plurality of passages formed therethrough;
a key securing device that securely receives the plurality of posts on an opposite side of the structural element from the key cap in a post-receiving structure formed therein, the key securing device comprising a key switch interface on a lower surface thereof; and
a key switch layer comprising a key switch that interacts with the key switch interface and registering a key press;
wherein the key securing device is mechanically unstable with respect to the key switch when not properly engaged with the plurality of posts;
wherein the key cap and the key securing device move substantially in unison when the key posts are securely received in the key securing device; and
wherein depressing the key cap causes the key switch interface that securely receives the key posts for the key cap to actuate the key switch.

12. The mechanical keypad of claim 11, wherein the key securing device is configured to be damaged when the key post is removed.

13. The mechanical keypad of claim 11, wherein the post receiving structure comprises a recess.

14. The mechanical keypad of claim 11, wherein the post receiving structure comprises an opening.

15. The mechanical keypad of claim 11, wherein the key switch is centered between the plurality of posts.

16. The mechanical keypad of claim 11, wherein the mechanical keypad is positioned in a housing, and further comprising an alarm switch comprising a security element associated therewith, the security element positioned between the housing and the alarm switch such that when the housing and the alarm switch are separated, the alarm switch is activated.

17. The mechanical keypad of claim 11, wherein a bottom surface of the key securing device comprises a convex portion.

18. The mechanical keypad of claim 11, wherein the key switch interface protrudes from the key securing device.

19. The mechanical keypad of claim 11, wherein the structural element comprises a recess formed on a lower surface thereof, wherein the recess is provided for the key securing device.

20. The mechanical keypad of claim 11, further comprising a spring between the structural element and the key cap such that when the key cap is depressed, the spring compresses before the key securing device moves.
